(19) United States
(12) Patent Application Publication
(10) Pub. No.: US 2025/0263591 A1
(43) Pub. Date: Aug. 21, 2025

(54) RIGID POLYURETHANE FOAM FORMULATION AND METHOD TO MAKE FIBER REINFORCED POLYURETHANE FOAM SUITABLE FOR CRYOGENIC APPLICATIONS

(71) Applicant: Dow Global Technologies LLC, Midland, MI (US)

(72) Inventors: Luca Lotti, Rubiera (IT); Thomas Mosciatti, Modena (IT)

(21) Appl. No.: 18/859,317

(22) PCT Filed: Jun. 2, 2023
(86) PCT No.: PCT/US2023/067814

§ 371 Date: Oct. 23, 2024

(30) Foreign Application Priority Data
Jun. 10, 2022 (IT) 102022000012320

(51) Int. Cl. C09J 175/12; B29C 41/00; B29C 41/28; B29K 75/00; B29K 309/08; C08G 18/24; C08G 18/32; C08G 18/40; C08G 18/42; C08G 18/48; C08G 18/50; C08G 18/66; C09J 5/08

(52) U.S. Cl. CPC C09J 175/12; C08G 18/246; C08G 18/3206; C08G 18/4018; C08G 18/42; C08G 18/482; C08G 18/4829; C08G 18/5027; C08G 18/6674; C09J 5/08; B29C 41/003; B29C 41/28; B29K 2075/00; B29K 2309/08; C08G 2110/0025; C08G 2110/0058; C08G 2110/0066; C08G 2110/0083; C08G 2170/60; C09J 2400/146; C09J 2475/00

(57) ABSTRACT

A polyol composition suitable for making rigid polyurethane foam includes a combination of five polyols, a surfactant and a polyurethane gelling catalyst. The polyol composition contains at most a very small quantity of a blowing catalyst. The polyol composition surprisingly produces, upon reaction with a polyisocyanate in the presence of a physical blowing agent, a polyurethane foam that exhibits little or no loss of compressive strength when overpacked. The polyol composition is especially useful for making fiber-reinforced rigid foams useful in cryogenic applications.

This invention relates to polyol formulations useful for making rigid polyurethane foam and methods for making fiber reinforced polyurethane foam, particularly those suitable for cryogenic applications such as liquified natural gas (LNG) storage tanks.

Very large quantities of LNG are transported by sea as an alternative to pipelines whose use may be constrained by geography, political situations or for other reasons. The natural gas typically is liquified onshore, then fed into large tanks on ships. Liquification requires temperatures of the order of −150° C. or lower. Storage and transportation also must be done at those temperatures to prevent evaporation and large pressure increases in the storage and handling equipment. This requires cryogenic equipment and robust thermal insulation.

Rigidity and structural integrity are important because of the weights involved and because the tanks are subject to pressures arising from the momentum of sea waves transferred to the tanks, which produces wave motion within the tanks.

Rigid polyurethane foams are the material of choice for the thermal insulation. These foams are also called upon to contribute to the rigidity and structural integrity of the storage tanks. Therefore, the mechanical properties of the foam are very important; consequently, the foams are generally fiber-reinforced to further enhance mechanical properties.

These fiber-reinforced rigid polyurethane foams are conveniently made in continuous processes in which fiber mats are laid down onto a moving platform and a foam precursor fluid is applied onto the fiber mats. The foam precursor fluid must penetrate through the fiber mats as it expands and cures to form the foam. Viscosity is important because the foam precursor fluid does not penetrate adequately through the fibers if it is too viscous. Poor penetration leads to poor distribution of the fibers throughout the resulting foam, which adversely affects both its physical and thermal properties.

The need to maximize mechanical properties such as compressive strength restrains the production process. Certain mechanical properties of the foam such as compressive strength tend to be maximized when the foam is produced under “free-rise” conditions, i.e., the foam is allowed to expand unconstrained in the vertical direction. Foams produced in this way do not have a sharp rectangular cross-section because the top surface of the foam is curved. The foam thickness therefore varies from its edges to the middle. For that reason, the foam is subjected to subsequent trimming steps to produce a clean rectangular cross-section and a panel with uniform dimensions. Trimming adds costs and also produces a significant amount of waste, as an oversized foam is produced which is then cut down to size.

Trimming can be avoided by constraining the vertical rise of the foam and “overpacking”, i.e., using a small excess of foam precursor over the minimally needed amount to produce a foam of a specific volume. Unfortunately, the compressive strength of the foam often diminishes when the foam itself is overpacked. This phenomenon is generally attributed to foam cell anisotropy; the loss of compressive strength due to overpacking often outweighs the advantages of eliminating the trimming step.

What is desired is a polyurethane foam formulation that when overpacked produces a foam without a significant loss of compressive strength, compared to an otherwise like foam that is not overpacked. Also desired is a method for producing fiber-reinforced foam panels that have good thermal insulation and good compressive strength properties, and which reduces or eliminates the need for trimming.

This invention is in a first aspect a polyol composition comprising
a) polyols comprising
   P1: 15 to 30 weight percent, based on the weight of all polyols, of one or more non-amine-initiated polyether polyols having a nominal functionality of 4 to 8 and a hydroxyl number of 300 to 600 mg KOH/g;
   P2: 18 to 35 weight percent, based on the weight of all polyols, of one or more non-amine-initiated polyether polyols having a nominal functionality of 3 and a hydroxyl number of 150 to 700 mg KOH/g;
   P3: 15 to 35 weight percent, based on the weight of all polyols, of one or more polyester polyols having a nominal functionality of 1.5 to 2.5 and a hydroxyl number of 150 to 300 mg KOH/g;
   P4: 2 to 8 weight percent, based on the weight of all polyols, of one or more amine-initiated polyether polyols having a nominal functionality of 3 to 8 and a hydroxyl number of 300 to 600 mg KOH/g; and
   P5: 10 to 25 weight percent, based on the weight of all polyols, of one or more diols having a nominal functionality of 2 and a hydroxyl number of at least 550 mg KOH/g;
   wherein polyols P1-P5 together constitute at least 95% of the total weight of all polyols;
b) 0 to 0.2 weight percent water, based on the weight of the polyol composition;
c) 0.1 to 2.5 weight percent of a surfactant, based on the weight of the polyol composition; and
d) a catalytically effective amount of a polyurethane gelling catalyst.

This polyol composition is especially well-adapted for use in making fiber-reinforced polyurethane foam by reaction with a polyisocyanate in the presence of a physical blowing agent and reinforcing fibers. It has a desirable low viscosity and slow initial cure. These attributes favor good penetration of the foam precursor fluid into the fibers, which results in good product uniformity and consistent properties. The foam so produced has good thermal insulation and compressive strength properties. Very surprisingly, the innovative formulation results in a fiber-reinforced foam that retains its compressive strength even when overpacked. This behavior is unusual and unexpected. The ability to overpack allows one to manufacture the fiber-reinforced polyurethane in precise dimensions, with little or no need for trimming. This reduces waste and eliminates or reduced the cost of trimming.

Accordingly, the invention is also a polyurethane foam made in a reaction of a polyol composition of the first aspect of the invention with at least one polyisocyanate in the presence of a physical blowing agent, wherein said reaction is performed in the presence of no more than 0.2 weight percent water based the weight of the polyol composition and no more than 0.1 weight percent of a blowing catalyst, based on the weight of the polyol composition.

The invention is also a method of making a polyurethane foam comprising reacting a polyol composition of the first aspect of the invention with at least one polyisocyanate in the presence of a physical blowing agent, wherein said reaction is performed in the presence of no more than 0.2 weight percent water based the weight of the polyol composition and no more than 0.1 weight percent of a blowing catalyst, based on the weight of the polyol composition.

In yet another aspect, the invention is a method for making fiber-reinforced polyurethane foam, the method comprising the steps of
A) dispensing a foam precursor fluid onto a bed of a reinforcing fibers and
B) curing the foam precursor fluid in the presence of the reinforcing fibers to produce the fiber-reinforced polyurethane foam,
wherein the foam precursor fluid comprises at least one polyisocyanate, at least one physical blowing agent and a polyol composition, the polyol composition comprising polyols comprising
   Polyol P1: 15 to 30 weight percent, based on the weight of all polyols, of one or more non-amine-initiated polyether polyols having a nominal functionality of 4 to 8 and a hydroxyl number of 300 to 600 mg KOH/g;
   Polyol P2: 18 to 35 weight percent, based on the weight of all polyols, of one or more non-amine-initiated polyether polyols having a nominal functionality of 3 and a hydroxyl number of 150 to 700 mg KOH/g;
   Polyol P3: 15 to 35 weight percent, based on the weight of all polyols, of one or more polyester polyols having a nominal functionality of 1.5 to 2.5 and a hydroxyl number of 150 to 300 mg KOH/g;
   Polyol P4: 2 to 8 weight percent, based on the weight of all polyols, of one or more amine-initiated polyether polyols having a nominal functionality of 4 to 8 and a hydroxyl number of 300 to 600 mg KOH/g; and
   Polyol P5: 10 to 25 weight percent, based on the weight of all polyols, of one or more diols having a nominal functionality of 2 and a hydroxyl number of at least 550 mg KOH/g;
   wherein polyols P1-P5 together constitute at least 95% of the total weight of all polyols;
      wherein the foam precursor fluid further contains i) 0.1 to 2.5 weight percent of a surfactant, based on the weight of the polyol composition, ii) a catalytically effective amount of a polyurethane gelling catalyst and iii) 0 to no more than 0.2 weight percent water based the weight of the polyol composition.

The P1 Polyol is one or more non-amine-initiated polyether polyols having a nominal functionality of 4 to 8 and a hydroxyl number of 300 to 600 mgKOH/g. The nominal functionality may be at least 5 or at least 6, and may be up to 8, for example. The hydroxyl number in some embodiments is up to 350 mgKOH/g and in some embodiments is up to 500 mgKOH/g. The P1 polyol is, in some embodiments, an alkoxylate of an initiator compound having 4 to 8 hydroxyl groups. Examples of such initiator compounds include pentaerythritol, erythritol and sugars having 4 to 8 hydroxyl groups such sorbitol and sucrose. The initiator is alkoxylated by reaction with one or more alkylene oxides, of which 1,2-propylene oxide, ethylene oxide, or a mixture of propylene oxide and ethylene oxide are preferred. An especially preferred P1 polyol is a propoxylate of sucrose a propoxylate of sorbitol, or a mixture thereof. The P1 polyol constitutes at least 15 weight percent of all polyols in the polyol mixture, and up to 30 weight percent thereof. In specific embodiments, the P1 polyol constitutes at least 18 weight percent of all polyols and may constitute up to 25 weight percent or up to 22 weight percent thereof.

The P2 Polyol is one or more non-amine-initiated polyether polyols having a nominal functionality of 3 and a hydroxyl number of 150 to 700 mgKOH/g. The hydroxyl number in some embodiments is at least 225 mg KOH/g or at least 350 mgKOH/g. The P2 Polyol is, in some embodiments, an alkoxylate of an initiator compound having 3 hydroxyl groups. Examples of such initiator compounds include glycerine, trimethylolpropane and trimethylolethane. The initiator is alkoxylated by reaction with one or more alkylene oxides, of which 1,2-propylene oxide, ethylene oxide, or a mixture of propylene oxide and ethylene oxide are preferred. A propoxylate of glycerine or trimethylolpropane is especially preferred. The P2 polyol constitutes at least 18 weight percent of all polyols in the polyol mixture, and up to 35 weight percent thereof. In specific embodiments, the P2 polyol constitutes at least 20 weight percent, at least 22 weight percent or at least 25 weight percent of all polyols and may constitute up to 32 weight percent or up to 30 weight percent thereof.

The P3 Polyol is one or more polyester polyols having a nominal functionality of 1.5 to 2.5 and a hydroxyl number of 150 to 300 mgKOH/g. The nominal functionality preferably is 1.5 to 2.2. The polyester is preferably an aromatic polyester, such as can be produced in a reaction of an aromatic dicarboxylic acid (or derivative such as the corresponding anhydride or alkyl diester thereof) with a diol or diol/triol mixture. Examples of such diols and triols include ethylene glycol, diethylene glycol, triethylene glycol, propylene glycol, dipropylene glycol, glycerin and the like. The P3 polyol constitutes at least 15 weight percent of all polyols in the polyol mixture, and up to 35 weight percent thereof. In specific embodiments, the P3 polyol constitutes at least 20 weight percent, at least 22 weight percent or at least 25 weight percent of all polyols and may constitute up to 32 weight percent or up to 30 weight percent thereof.

The P4 polyol is an amine-initiated polyol having a nominal functionality of 4 to 8 and a hydroxyl number of 300 to 600 mg KOH/g. The P4 Polyol is an alkoxylate of one or more amine compounds having at least 4 aminic hydrogens. The amine compound preferably is aromatic, and most preferably is o-toluene diamine, p-toluene diamine or a mixture of o-toluene diamine and p-toluene diamine. The amine compound is alkoxylated by reaction with one or more alkylene oxides, of which 1,2-propylene oxide, ethylene oxide, or a mixture of propylene oxide and ethylene oxide are preferred. A propoxylate of toluene diamine, especially o-toluene diamine, is especially preferred. The P4 polyol constitutes at least 2 weight percent of all polyols in the polyol mixture, and up to 8 weight percent thereof. In specific embodiments, the P4 polyol constitutes at least 4 weight percent, at least 5 weight percent or at least 6 weight percent of all polyols and may constitute up to 7.5 or up to 7 weight percent thereof.

The P5 polyol is one or more diols having a nominal functionality of 2 and a hydroxyl number of at least 550 mgKOH/g. Examples of these include ethylene glycol, diethylene glycol, triethylene glycol, propylene glycol, dipropylene glycol and tripropylene glycol. Diethylene glycol or a mixture of diethylene glycol and tripropylene glycol is preferred. The P5 polyol constitutes at least 10 weight percent of all polyols in the polyol mixture, and up to 25 weight percent thereof. In specific embodiments, the P5 polyol constitutes at least 12 weight percent or at least 15 weight percent of all polyols and may constitute up to 22 weight percent or up to 20 weight percent thereof.

The P1-P5 polyols together constitute at least 95% of the total weight of all polyols. They may together constitute at least 96%, at least 97% or at least 98% of the total weight of all polyols, and may constitute up to 100% of the total weight of all polyols.

Water, if present at all, is present in an amount of no more than 0.2% of the total weight of the polyol composition. A preferred amount is no more than 0.15% or no more than 0.125% of the total weight of the polyol composition.

The surfactant may be, for example, a silicone surfactant such as a polyether-modified polydimethylsiloxane surfactant. The surfactant may be hydrolyzable or non-hydrolyzable. Useful silicone surfactants are available under the trade names Tegostab® (Evonik), VORASURF™ (Dow, Inc.), or Silstab® (Siltech Corporation). The surfactant is not counted toward the weight of the polyols. The polyol composition contains 0.1 to 2.5% by weight of the surfactant; a preferred amount is 0.5 to 2.0% or 0.75 to 1.5% by weight.

The polyol composition further comprises at least one gelling catalyst. For purposes of this invention, a “gelling” catalyst is a catalyst that promotes the reaction of an isocyanate group towards an alcohol group more strongly than it promotes the reaction of an isocyanate group toward a water molecule. The relative catalytic activity of a catalyst toward the isocyanate-alcohol reaction vs. the isocyanate-water reaction may be determined using a titration method such as is described by van Maris et al., “Polyurethane Catalysis by Tertiary Amines”, J. Cellular Plastics 41 (July 2005), pp. 305-322. The catalytic activity towards the isocyanate-alcohol reaction is evaluated by reacting 50 mL of a 0.1533 mol/L solution of 2,4-toluene diisocyanate in benzene with 50 mL of a 0.1533 mol/L solution of diethylene glycol in benzene, in the presence of 5 ML of a 0.0735 mol/L solution of the catalyst in benzene at 30° C. Samples are taken at various times and the unreacted isocyanate is quenched with a solution of n-butylamine in benzene. The remaining isocyanate content in each sample is determined by back titration with a standardized HCl solution. The NCO contents of the samples are then used to calculate a gelling activity in units of L²/g-mol-hr. The catalytic activity toward the isocyanate-alcohol reaction is evaluated in the same way, substituting a 0.0752 mol/L solution of water in benzene for the diethylene glycol solution. A “gelling” catalyst is one in which the ratio of blowing: gelling catalytic activity is <0.5. A preferred gelling catalyst is one in which this ratio is <0.2 and a more preferred gelling catalyst is one in which this ratio is <0.1 or <0.05.

Examples of gelling catalysts include permethylated alkylene diamines, diethylene triamine, imidazoles, metal-containing catalysts such as tin, zinc and bismuth carboxylates, and in particular tin (IV) catalysts such as dimethyl tin dilaurate, dibutyl tin dilaurate, dimethyl tin dioctoate, dibutyl tin dioctoate, and tin (IV) thioglycolates having the structure R₂Sn(Tg)₂, where each R is independently C1-10 alkyl and each Tg is independently a thioglycolate ester group of the form R′OOC—CH₂—S— where R′ is C1-10 alkyl.

Specific examples of gelling catalysts include:

| | Blowing:Gelling Catalytic Activity |
|---|---|
| Catalyst | Ratio |
| Tetramethylhexamethylene diamine | 0.285 |
| Tetramethylethylene diamine | 0.227 |
| Triethylene diamine | 0.134 |
| Dimethylaminoethanol | 0.123 |
| 1,2-Dimethylimadazole | 0.077 |
| Tosoh F22 Catalyst | 0.032 |
| Dibutyltin dilaurate | 0.030 |

The polyol composition preferably contains at most 0.1 weight percent of a blowing catalyst, based on the total weight of the polyol composition. A “blowing” catalyst for purposes of this invention is one which exhibits a ratio of blowing: gelling catalytic activity, measured according to the titration method described above, of 0.5 or greater. The polyol composition preferably contains at most 0.05 weight percent of a blowing catalyst and more preferably contains at most 0.025 weight percent thereof. The polyol composition may contain no blowing catalyst at all.

For purposes of this invention, the P4 polyol is not considered as either a blowing or gelling catalyst, although it may exhibit catalytic activity due to the presence of tertiary amino groups.

In preferred embodiments, the gelling catalyst exhibits a blowing;gelling catalytic activity ratio less than 0.2 and the polyol composition contains no more than 0.1 weight percent, no more than 0.05 weight percent or nor more than 0.025 weight percent of a catalyst exhibiting a blowing: gelling catalytic activity ratio of 0.2 or higher.

The polyol composition is in general useful for making rigid polyurethane foam by reaction with a polyisocyanate in the presence of a physical (endothermic) blowing agent. Methods of making such rigid polyurethane foams are well-known in the art.

The physical blowing agent is one or more compounds that have boiling temperatures (at 1 atmosphere pressure) of 10° C. to 80° C., preferably 10° C. to 50° C., and which lack hydroxyl, primary and/or secondary amine, thiol, carboxyl or other groups other than halogen groups that are reactive toward isocyanate groups under the conditions of the curing reaction. Useful physical blowing agents include hydrocarbons, hydrofluorocarbons, hydrochlorocarbons, hydrofluorochlorocarbons, ethers and the like that have the aforementioned boiling temperatures. Also useful are hydrofluoroolefins and hydrofluorochloroolefins such as described, for example, in US 2007/0100010. Specific examples thereof are trifluoropropene, 1,3,3,3-tetrafluoropropene (1234ze), 1,1,3,3-tetrafluoropropene, 2,2,3,3-tetrafluoropropene (1234yf), 1,2,3,3,3-pentafluoropropene (1225ye), 1,1,1-trifluoropropene, 1,1,1,3,3-pentafluoropropene (1225zc), 1,1,2,3,3-pentafluoropropene (1225yc), (Z)-1,1,1,2,3-pentafluoropropene (1225yez), 1-chloro-3,3,3-trifluoropropene (1233zd) and 1,1,1,4,4,4-hexafluorobut-2-ene (1336mzzm). Mixture of any two or more physical blowing agents can be used.

The physical blowing agent may, for example, be present in an amount of at least 12 parts by weight per 100 parts by weight of the polyol(s). The amount of physical blowing agent may be, for example, at least 12, at least 14 or at least 15 parts by weight on that basis and may be, for example, up to 25 parts, up to 22 parts, up to 20 parts or up to 18 parts, again on the same basis.

Suitable organic polyisocyanates for use in the invention include aliphatic, cycloaliphatic, araliphatic or aromatic polyisocyanates, or combinations of any two or more thereof. Aromatic polyisocyanates are generally preferred. Among the preferred aromatic diisocyanates and polyisocyanates, are 2,4- and 2,6-toluene diisocyanate and the corresponding isomer mixtures, 4,4′-, 2,4′- and 2,2′-diphenylmethane diisocyanate and the corresponding isomer mixtures, mixtures of 4,4′- and 2,4′-diphenylmethane diisocyanates, polyphenylpolymethylene polyisocyanates, mixtures of 4,4′-, 2,4′- and/or 2,2′-diphenylmethane diisocyanates with polyphenylpolymethylene polyisocyanates (generally referred to in the art as “polymeric MDI”), and mixtures of polymeric MDI and toluene diisocyanates. Modified polyisocyanates, i.e., products which are obtained by chemical reaction of organic diisocyanates and/or polyisocyanates, may also be used. Specific examples are ester-, urea-, biuret-, allophanate-, uretoneimine-, carbodiimide-, isocyanurate-, uretdione- and/or urethane-containing diisocyanates and/or polyisocyanates, that contain from 33.6 to 15 percent by weight, preferably from 31 to 21 percent by weight, of isocyanate groups, based on the total weight of the modified polyisocyanate. The organic polyisocyanates may be employed individually or in the form of combinations thereof. Polymeric MDI having an isocyanate functionality of 2.2 to 3.3, especially 2.5 to 3.0, and an isocyanate equivalent weight of 130 to 140 is especially preferred.

The polyol composition is especially useful for making fiber-reinforced polyurethane foam. Such fiber-reinforced foam is conveniently made in a process that comprises
A) dispensing a foam precursor fluid onto a bed of a reinforcing fibers and B) curing the foam precursor fluid in the presence of the reinforcing fibers to produce the fiber-reinforced polyurethane foam, wherein the foam precursor fluid comprises at least one polyisocyanate, at least one physical blowing agent and a polyol composition of the invention.

The reinforcing fibers are conveniently provided in the form of a mat of continuous or discontinuous fibers which are held together mechanically (such as by needlepunching, entanglement or otherwise) or by means of a small amount of binder. An especially preferred mat includes randomly oriented continuous filaments and no binder. The fibers preferably are glass fibers, but may be other fibers such mineral wool, carbon fibers, synthetic organic polymer fibers, natural fibers such as cotton, wool, silk and the like, metal fibers, and the like.

A fiber mat may have weight of 225-900 g/m².

The fibers are deposited onto a support. In a preferred continuous process, the support is moving, and the fibers are continuously deposited onto the moving support. The preferred fiber mat is conveniently fed onto the moving support from a roller. In an especially preferred embodiment, the moving support is a lower belt of a double belt laminator.

Enough of the fibers are deposited to provide a fiber content of preferably 5 to 25% or 5 to 15% by weight in the resulting fiber-reinforced polyurethane foam. Multiple layers of fiber mats may be stacked if necessary to provide the desired fiber content.

A facing layer may be laid onto the support prior to depositing the fibers.

The foam precursor fluid is then dispensed onto the fiber bed via a dispensing apparatus. Spraying and pouring methods are generally suitable. The foam precursor fluid may be dispensed onto the fiber bed via a distributor apparatus that applies the foam precursor fluid in multiple streams across the transverse width of the fiber bed. Examples of such distributor apparatus are described, for example, in EP2125323A, EP2234732A, WO 2021/045888, WO 2021/046019, WO 2021/046020, WO 2021/046021 and WO 2012/046022. The multiple streams expand and merge as the foam precursor fluid cures. In preferred embodiments, a stationary dispensing apparatus continuously dispenses the foam precursor fluid onto the fiber bed as the fiber bed is transported past the dispensing apparatus on a moving platform.

The foam precursor fluid penetrates through the fiber bed and expands and cures to produce a polyurethane foam having the reinforcing fibers embedded therein. An advantage of the polyol composition of the invention is that it reacts somewhat slowly, at least at early stages of cure, so it does not build viscosity quickly and for that reason has time to permeate between the fibers of the fiber bed. This results in a more uniform distribution of the fibers in the product and reduces defects like dry spots and regions devoid of fibers.

Curing conditions are selected such that the blowing agent volatilizes and the reactive components of the foam precursor fluid react to produce a polymer foam. The conditions typically include a temperature above the boiling temperature of the physical blowing agent at the pressures employed. The curing reaction is exothermic and the exothermic heat of reaction is often sufficient by itself to volatilize the physical blowing agent to produce a gas that expands the foam. Therefore, no special conditions are necessary to promote the cure. The foam precursor fluid may be produced by combining the ingredients at approximately room temperature (such as 15 to 30° C.), applying the foam precursor fluid to the fiber bed so that it penetrates through the fiber bed, and then allowing the foam precursor to react spontaneously without additional applied heat. It is sometimes beneficial to accelerate the cure by applying heat to the foam precursor fluid, before and/or after it is dispensed onto the fiber bed. This may be done by, for example, by heating one or more components of the foam precursor fluid prior to combining them; or by heating the fiber bed after the foam precursor fluid has been dispensed onto it. In some embodiments, the moving platform carrying the fiber bed is heated; alternatively or in addition an upper surface that constrains the vertical rise of the foam curing the curing step may heated to provide heat to accelerate the cure. Heating, if done, may be to a temperature of, for example, 35 to 100° C., especially 35 to 50° C.

In some embodiments, the foam precursor fluid is permitted to expand unconstrained in the vertical direction. An advantage of this invention, however, is seen when the vertical rise is instead constrained and especially when the vertical rise is constrained to a height less than that to which the foam precursor fluid rises without constraint. This results in overpacking. Unlike other foam systems, it has been found that no or reduced loss of compressive strength is seen when the foam is overpacked by, for example, 1 to 15% or 3 to 10% by weight. The amount of overpacking is calculated as follows:

$$\% overpacking = \frac{{density}_{foam}}{minimum fill density} \times 100 \%$$

wherein density_{foam} is the density of the polyurethane foam (excluding the weight of the reinforcing fibers) and the minimum fill density is the density of a foam (again, excluding the weight of the reinforcing fibers) that rises to the same height in the same process except under free rise conditions, i.e., in the absence of a vertical constraint. Equivalently, % overpacking can be calculated as 100% times the ratio of the weight of the foam of a specific vertical height per unit area to the weight per unit area of a foam that rises to the same height in the same process except under free rise conditions. Foam density is conveniently measured according to ASTM D 1622.

The vertical rise of the foam is conveniently constrained mechanically, i.e., by the placement of a physical barrier that restricts further vertical rise. The vertical expansion of the foam precursor fluid in some embodiments is constrained by an upper belt of the double belt laminator. In such an embodiment, the upper and lower belts of the double belt laminator is adjusted to provide a gap between them. This gap defines the thickness of the product. The gap is selected so the foam is overpacked, i.e., the gap is smaller than the height to which the foam would rise vertically if not constrained. The foam precursor fluid expands and rises as it cures, being constrained in its vertical rise by the bands of the double band laminator, preferably across its entire width, resulting in overpacking, a flat top surface and a rectangular cross-section. The lateral expansion of the foam precursor fluid may be constrained as well, such as by enclosing the fiber bed and foam precursor fluid within side walls.

A suitable method for making the foam is described in WO 2020/193874. The method of WO 2020/193874 further includes the use of lateral side walls to constrain the lateral expansion of the foam precursor fluid.

When the vertical rise of the foam is constrained, the constraint should remain in place until the foam has cured enough to have a stable vertical dimension.

An upper facing layer may be laid on top of the fiber bed with dispensed foam precursor fluid, if desired, to produce a top facing layer that becomes adhered to a top surface of the fiber-reinforced polyurethane foam.

Examples of facing layers include paper, plywood, decorative films, metal foils and sheets, particularly aluminum foil and steel sheets, and the like. In a preferred embodiment, it is paper.

The invention is especially suitable for making insulation panels for cryogenic applications, and more particularly for making insulation panels for liquified natural gas or other liquified gas storage tanks. These foams may have thicknesses of, for example 200 to 500 mm, which large thicknesses tend to distinguish them from more general-purpose laminated panels. A fiber-reinforced polyurethane foam useful in these applications may have a foam density of 80 to 150 kg/m³. Such densities provide a good balance of thermal insulation and mechanical strength (especially compressive strength). Such foams may be produced in widths that range from 100 mm to 5 meters, especially 300 mm to 2.5 meters or 500 mm to 2 meters. In a preferred embodiment, the width is 800-1200 mm.

The method of the invention may and preferably does include one or more downstream steps, such as cutting the fiber-reinforced polyurethane foam to a desired length, cooling the foam from the curing temperature, stacking the foam, and wrapping the foam or otherwise preparing it for shipment or storage.

The following examples are provided to illustrate the invention but are not intended to limit the scope thereof. All parts and percentages are by weight unless otherwise indicated.

Polyol A is a propoxylate of sorbitol, having a functionality of 6 and a hydroxyl number of 477 mg KOH/g (118 Da equivalent weight). This is a P1 polyol.

Polyol B is a propoxylated mixture of sucrose and glycerine. Its hydroxyl number is 360 mg KOH/g (156 Da equivalent weight). Polyol 2 contains approximately 58% by weight of octafunctional species (P1 polyol) and 42% by weight trifunctional species (P2 polyol).

Polyol C is a propoxylated glycerine. Its hydroxyl number is 665 mg KOH/g (83 Da equivalent weight) and its functionality is 3. This is a P2 polyol.

Polyol D is a propoxylated glycerine. Its hydroxyl number is 378 mg KOH/g (156 Da equivalent weight) and its functionality is 3. This is a P2 polyol.

Polyol E is a propoxylated glycerine. Its hydroxyl number is 239 mg KOH/g (235 Da equivalent weight) and its functionality is 3. This is a P2 polyol.

Polyol F is an aromatic polyester polyol having a hydroxyl number of 240 mg KOH/g (234 Da equivalent weight) and a functionality of 2. Its viscosity, as reported by the manufacturer, is 2,000 to 4,500 cP at 25° C. Polyol Fis a P3 polyol.

AEP is a propoxylated o-toluenediamine having a hydroxyl number of 440 mg KOH/g (127.5 Da equivalent weight) and a functionality of 4. AEP is a P4 polyol.

DPG is dipropylene glycol, hydroxyl number 834 mg KOH/g (67 Da equivalent weight), functionality 2.0. It is a P5 polyol.

TPG is tripropylene glycol, hydroxyl number 584 mg KOH/g (96 Da equivalent weight), functionality 2.0. It is a P5 polyol.

DBTDL is dibutyltindilaurate.

The Polyisocyanate is a polymeric MDI having an isocyanate functionality=2.7, isocyanate equivalent weight 136 Da, and containing 40% MDI monomer.

### EXAMPLE 1 AND COMPARATIVE SAMPLE A-C

Polyol systems are prepared by mixing ingredients as listed in Table 1.

TABLE 1

Parts By Weight

| Ingredient | 1 | A* | B* | C* |
|---|---|---|---|---|
| Polyol A | 14.8 | 31.58 | 31.61 | 20.68 |
| Polyol B | 8.0 | 2.63 | 25.56 | 0 |
| Polyol C | 0 | 5.70 | 0. | 5.64 |
| Polyol D | 25.0 | 0 | 0 | 0 |
| Polyol E | 0 | 30.83 | 0 | 30.83 |
| AEP | 7.0 | 0 | 0 | 0 |
| Polyol F | 26.0 | 23.53 | 23.53 | 23.53 |
| DPG | 18.0 | 4.51 | 18.05 | 18.05 |
| TPG | 0.68 | 0.67 | 0.68 | 0.67 |
| DBTDL | 0.035 | 0.036 | 0.036 | 0.035 |
| Surfactant | 1.20 | 1.18 | 1.18 | 1.18 |
| Water | 0.10 | 0.10 | 0.10 | 0.10 |
| Wt. P1 Polyols¹ | 19.42 | 33.10 | 46.41 | 20.68 |
| Wt. P2 Polyols² | 28.38 | 38.04 | 10.76 | 36.47 |
| Wt. P3 Polyols | 26.0 | 23.53 | 23.53 | 23.53 |
| Wt. P4 Polyols | 7.0 | 0 | 0 | 0 |
| Wt. P5 Polyols³ | 18.68 | 5.18 | 18.73 | 18.72 |

*Not an example of this invention.
¹Combined weight of Polyol A and sucrose-initiated portion of Polyol B.
²Combined weights of the glycerin-initiated portion of Polyol B, and Polyols C, D and E.
³Combined weights of DPG and TPG.

Non-reinforced foam Example 1 and Comparative Samples A-C are produced from polyol systems and A-C, respectively, as follows: The catalyst is mixed with the TPG. The remaining ingredients of the polyol system are mixed separately to form a polyol composition. These two mixtures are combined together with 7.2 parts by weight of 1,1,1,3,3-pentafluoropropane per 100 parts of the polyol composition to form a blend, and the blend is mixed with the Polyisocyanate through a high pressure machine at an index of 116.1 (iso/OH). The resulting reaction mixture is dispensed into a 30 cm×30 cm×10 cm parallelepipedon mold, where it rises and cures to produce a foam having a density of 125 g/L. Results are indicated as the “No Fiber” case in Table 2. Sample designations correspond to those of the polyol systems.

Fiber-reinforced panels are produced from polyol systems 1 and A-B. Because the compressive strength of the non-reinforced foam made from polyol system Cis so low, that formulation is not used to make fiber-reinforced panels. The fiber-reinforced panels are made in a double-belt lamination process, using paper as facers on both the bottom and top sides of the foam. The foam thickness is set at 300 mm and the nominal width is 1050 mm.

The bottom facer is fed into the laminator. 6 layers of a continuous strand fiberglass mat (Unifilo U809, from Owens Corning) are stacked onto the bottom facer, so to provide an approximate fiber concentration of 10% by weight in the resulting composite panel. The catalyst/TPG mixture, the remainder of the polyol system, the blowing agent (1,1,1,3,3-pentafluropropane) and the Polyisocyanate (116.1 (iso/OH). index) are processed through a high-pressure foam machine and cast onto the stacked fiberglass mats and bottom facer in a continuous manner. The amount of the reaction mixture is selected so that it rises freely upon curing to produce a reinforced foam having a thickness of 300 mm and a density of approximately 125 g/L. The top facer is applied continuously onto the foaming reaction mixture. The assembly is passed between heated belts of the double belt laminator, during which time the foaming reaction mixture expands and cures to form a laminated panel having top and bottom paper facer layers and a reinforced foam layer. This represents a “0% overpacking” (“0% OP”) case, because the vertical rise of the foam is unconstrained by the belts of the double belt laminator. This panel has a curved top surface, as it does not fully expand to meet the surface of the top belt across the entire width of the panel. Accordingly, this panel would require subsequent trimming to produce a uniform, rectangular cross-section.

Additional reinforced foams are made in the same general manner, but at decreasing line speed. Decreasing the line speed has the effect of increasing the amount of reaction mixture applied per unit area, which results in overpacking and slightly reducing the weight of fiberglass mats per unit area. These two effects result in reinforced foams that are overpacked up to 6%. The overpacked foams fully expand to contact the upper belt across its entire width, producing a uniform rectangular cross-section that does not require trimming.

Compressive strength is measured according to EN 826 for the “No Fiber” foams, and for the 0% and 6% overpacked reinforced foams. A total of 27 test samples are cut from left, right and center sections of the foam reinforced panels and along its length (i.e., in the machine direction). The average compressive strength value of these 27 samples is as reported in Table 2. In addition, the number of individual samples that have a compressive strength of less than 1200 kPa is reported in Table 2. 1200 kPa is considered to be a minimally acceptable compressive strength for 125 g/L density glass-reinforced foam panels.

Thermal conductivity is also measured according to ISO 8301:1991.

TABLE 2

| | | | | |
|---|---|---|---|---|
| Test | Ex. 1 | Comp. A* | Comp. B* | Comp. C* |

Compressive Strength

| | | | | |
|---|---|---|---|---|
| No Fiber | 1130 | 1220 | 1320 | 765 |
| 0% Overpacking, | 1350 | 1125 | 1250 | N.D.¹ |
| with Fiber | | | | |
| 6% Overpacking, | 1370 | 1090 | 1140 | N.D.¹ |
| with Fiber | | | | |
| % Panels at 6% | 0 | 50 | 30 | N.D.¹ |
| Overpacking with | | | | |
| Compressive | | | | |
| Strength <1200 | | | | |
| kPa | | | | |
| Thermal Conductivity, | <24.5 | >25.0 | >25.0 | N.D.¹ |
| mW/(m · K) | | | | |

*Not an example of this invention.
¹Not determined due to excessively low compressive strength of the No Fiber foam.

As the “No Fiber” data shows, non-reinforced foam made from polyol systems A and B have higher compressive strengths than foam made from polyol system 1. However, this advantage of polyol systems A and B does not carry over when those polyol systems are used to make reinforced foam. In that case, foam Example 1, made using polyol system 1, exhibits a compressive strength markedly superior to those made using polyol systems A and B. At 0% overpacking, the compressive strengths of Comp. A and Comp. B are actually reduced by 5-10% compared to the No Fiber case, despite the presence of the fiber glass reinforcement. This is attributed to incomplete and uneven penetration of the reaction mixture into the fiber mats in those cases.

In contrast, the compressive strength of the 0% overpacked, fiber-reinforced Example 1 foam is significantly higher than the corresponding No Fiber case.

The 6% overpacking data demonstrates another important and unexpected advantage of this invention. In the cases of Comp. A and Comp. B, overpacking results in still a further decrease in Compressive Strength—about 3% in the case of Comp. A and about 9% in the case of Comp. B. Contrary to those results, Example 1 unexpectedly shows a small increase in Compressive Strength when overpacked. This is a significant practical advantage as overpacking permits the foam to be made with uniform cross-sectional dimensions with flat top and bottom surfaces. This reduces or even eliminates the need for a subsequent trimming step and associated waste.

1. A polyol composition comprising
a) polyols comprising
P1: 15 to 30 weight percent, based on the weight of all polyols, of one or more non-amine-initiated polyether polyols having a nominal functionality of 4 to 8 and a hydroxyl number of 300 to 600 mg KOH/g;
P2: 18 to 35 weight percent, based on the weight of all polyols, of one or more non-amine-initiated polyether polyols having a nominal functionality of 3 and a hydroxyl number of 150 to 700 mg KOH/g;
P3: 15 to 35 weight percent, based on the weight of all polyols, of one or more polyester polyols having a nominal functionality of 2 to 2.5 and a hydroxyl number of 150 to 300 mg KOH/g;
P4: 2 to 8 weight percent, based on the weight of all polyols, of one or more amine-initiated polyether polyols having a nominal functionality of 4 to 8 and a hydroxyl number of 150 to 300 mg KOH/g; and
P5: 10 to 25 weight percent, based on the weight of all polyols, of one or more diols having a nominal functionality of 2 and a hydroxyl number of at least 550 mg KOH/g;
wherein polyols P1-P5 together constitute at least 95% of the total weight of all polyols;
b) 0 to 0.2 weight percent water, based on the weight of the polyol composition;
c) 0.1 to 2.5 weight percent of a surfactant, based on the weight of the polyol composition; and
d) a catalytically effective amount of a polyurethane gelling catalyst.

2. The polyol composition of claim 1 wherein the polyol composition contains no more than 0.1 weight percent of a blowing catalyst.

3. The polyol composition of claim 2 wherein the polyurethane gelling catalyst is one or more of a permethylated alkylene diamine, diethylene triamine, an imidazole and metal-containing catalyst.

4. The polyol composition of claim 2 wherein the polyurethane gelling catalyst is one or more of dimethyl tin dilaurate, dibutyl tin dilaurate, dimethyl tin dioctoate, dibutyl tin dioctoate, and a tin (IV) thioglycolate having the structure R₂Sn(Tg)₂, where each R is independently C₁₋₁₀ alkyl and each Tg is independently a thioglycolate ester group of the form R′OOC—CH₂—S— where R′ is C₁₋₁₀ alkyl.

5. The polyol composition of claim 1 wherein the P1 polyol is a propoxylate of sucrose a propoxylate of sorbitol, or a mixture thereof; the P2 polyol is a propoxylate of glycerine or trimethylol propane; the P4 polyol is a propoxylate of o-toluene diamine, the P5 polyol is diethylene glycol or a mixture of diethylene glycol and tripropylene glycol and the polyol composition contains no more than 0.125% by weight water.

6. A polyurethane foam made in a reaction of a polyol composition of claim 1 with at least one polyisocyanate in the presence of a physical blowing agent, wherein said reaction is performed in the presence of no more than 0.2 weight percent water based the weight of the polyol composition and no more than 0.1 weight percent of a blowing catalyst, based on the weight of the polyol composition.

7. A method for making fiber-reinforced polyurethane foam, the method comprising the steps of
A) dispensing a foam precursor fluid onto a bed of a reinforcing fibers and
B) curing the foam precursor fluid in the presence of the reinforcing fibers to produce the fiber-reinforced polyurethane foam,
wherein the foam precursor fluid comprises at least one polyisocyanate, at least one physical blowing agent and a polyol composition, the polyol composition comprising polyols comprising
Polyol P1: 15 to 30 weight percent, based on the weight of all polyols, of one or more non-amine-initiated polyether polyols having a nominal functionality of 4 to 8 and a hydroxyl number of 300 to 600 mg KOH/g;
Polyol P2: 18 to 35 weight percent, based on the weight of all polyols, of one or more non-amine-initiated polyether polyols having a nominal functionality of 3 and a hydroxyl number of 150 to 700 mg KOH/g;
Polyol P3: 15 to 35 weight percent, based on the weight of all polyols, of one or more polyester polyols having a nominal functionality of 2 to 2.5 and a hydroxyl number of 150 to 300 mg KOH/g;
Polyol P4: 2 to 8 weight percent, based on the weight of all polyols, of one or more amine-initiated polyether polyols having a nominal functionality of 4 to 8 and a hydroxyl number of 150 to 300 mg KOH/g; and
Polyol P5: 10 to 25 weight percent, based on the weight of all polyols, of one or more diols having a nominal functionality of 2 and a hydroxyl number of at least 550 mg KOH/g;
wherein polyols P1-P5 together constitute at least 95% of the total weight of all polyols;
wherein the foam precursor fluid further contains i) 0.1 to 2.5 weight percent of a surfactant, based on the weight of the polyol composition, ii) a catalytically effective amount of a polyurethane gelling catalyst and iii) 0 to no more than 0.2 weight percent water based the weight of the polyol composition.

8. The method of claim 7 wherein the foam precursor fluid contains 0 to no more than 0.1 weight percent of a blowing catalyst, based on the weight of the polyol composition.

9. The method of claim 8 wherein in step A the bed of reinforcing fibers is laid onto a moving support and the foam precursor fluid is dispensed onto the reinforcing fibers on the moving support.

10. The method of claim 8 wherein in step B the foam precursor fluid expands in a vertical direction, and the vertical expansion of the foam precursor fluid is constrained to produce overpacking.

11. The method of claim 10 characterized by overpacking of 3 to 10% by weight.

12. The method of claim 9 wherein the moving support is a lower belt of a double belt laminator and the vertical expansion of the foam precursor fluid is constrained by an upper belt of the double belt laminator.

13. The method of claim 8 wherein the fiber-reinforced polyurethane foam has a thickness of 200 to 500 mm, a foam density of 80 to 150 kg/m³, and a reinforcing fiber content of 5 to 25% by weight.

14. The method of claim 8 wherein the reinforcing fibers are glass fibers.

15. The method of claim 8 wherein the polyurethane gelling catalyst is one or more of dimethyl tin dilaurate, dibutyl tin dilaurate, dimethyl tin dioctoate, dibutyl tin dioctoate, and a tin (IV) thioglycolate having the structure R₂Sn(Tg)₂, where each R is independently C1-10 alkyl and each Tg is independently a thioglycolate ester group of the form R′OOC—CH₂—S— where R′ is C1-10 alkyl; the P1 polyol is a propoxylate of sucrose a propoxylate of sorbitol, or a mixture thereof; the P2 polyol is a propoxylate of glycerine or trimethylol propane; the P4 polyol is a propoxylate of o-toluene diamine; the P5 polyol is diethylene glycol or a mixture of diethylene glycol and tripropylene glycol and the polyol composition contains no more than 0.125% by weight water.
